(19) United States
(12) Patent Application Publication
(10) Pub. No.: US 2013/0291107 A1
(43) Pub. Date: Oct. 31, 2013

(54) System and Method for Mitigating Application Layer Distributed Denial of Service Attacks Using Human Behavior Analysis

(71) Applicants: Shawn J. Marck, Los Angeles, CA (US); Jeffrey A. Lyon, Norfolk, VA (US); Robert C. Smith, Los Angeles, CA (US)

(72) Inventors: Shawn J. Marck, Los Angeles, CA (US); Jeffrey A. Lyon, Norfolk, VA (US); Robert C. Smith, Los Angeles, CA (US)

(73) Assignee: THE IRC COMPANY, INC., Wilmington, DE (US)

(21) Appl. No.: 13/458,129

(22) Filed: Apr. 27, 2012

(51) Int. Cl. G06F 21/00

(52) U.S. Cl. 726/23; 726/22

(57) ABSTRACT

A method of mitigating an application distributed denial of service (DDoS) attack on a network includes receiving at an application DDoS mitigation appliance application layer logs, parsing the application layer logs into an application layer forensic file, comparing an entry of the application layer forensic file with a human behavior profile to determine a malicious qualifier associated with an application DDoS attack on the network, parsing the application layer log into a per-source forensic file, comparing an entry of the per-source forensic files with the malicious qualifier to determine a malicious Internet protocol (IP) addresses associated with the application DDoS attack, and providing the malicious IP address to a network device, wherein the network device drops network traffic associated with the application DDoS attack based upon the malicious IP address.

### FIELD OF THE DISCLOSURE

The present disclosure generally relates to communications networks, and more particularly relates to mitigating distributed denial of service attacks in a communications network.

### BACKGROUND

A network, such as the Internet, allows users of the network to access the resources of a datacenter. A distributed denial-of-service attack (DDoS) attack is an attempt to make resources of the network unavailable to the users. A DDoS attack is performed in a concerted effort by multiple computers (bot) to prevent a targeted site or service of the datacenter from functioning efficiently. Perpetrators of DDoS attacks typically target sites or services hosted on high-profile web servers such as banks, credit card payment gateways, and even root nameservers. A common attack involves saturating the target machine with external communications requests, such that it cannot respond to legitimate traffic, or such that it responds so slowly that the target is effectively unavailable to legitimate traffic. As such, DDoS attacks can lead to a server overload, thus forcing the targeted computer to reset. The scope and content of DDoS attacks is constantly being adapted and changed in order to adapt to changes in the network environment, and to surmount improved network security measures that are employed by the network operator.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a schematic diagram of a network according to an embodiment of the present disclosure;

FIG. 2 is a schematic diagram of a botnet according to an embodiment of the present disclosure;

FIG. 3 is a schematic diagram illustrating a distributed denial of service (DDoS) attack on the network of FIG. 1 using the botnet of FIG. 2;

FIG. 4 is a schematic of a protected network according to an embodiment of the present disclosure;

FIG. 5 is a block diagram of an application DDoS mitigation appliance according to an embodiment of the present disclosure;

FIGS. 6-8 are block diagrams of different usage models for providing an application DDoS attack mitigation appliance in a protected network according to an embodiment of the present disclosure;

FIGS. 9 and 10 illustrate a method for mitigating distributed denial of service attacks in a communications network according to an embodiment of the present disclosure; and

FIG. 11 is a block diagram of a general computer system according to an embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

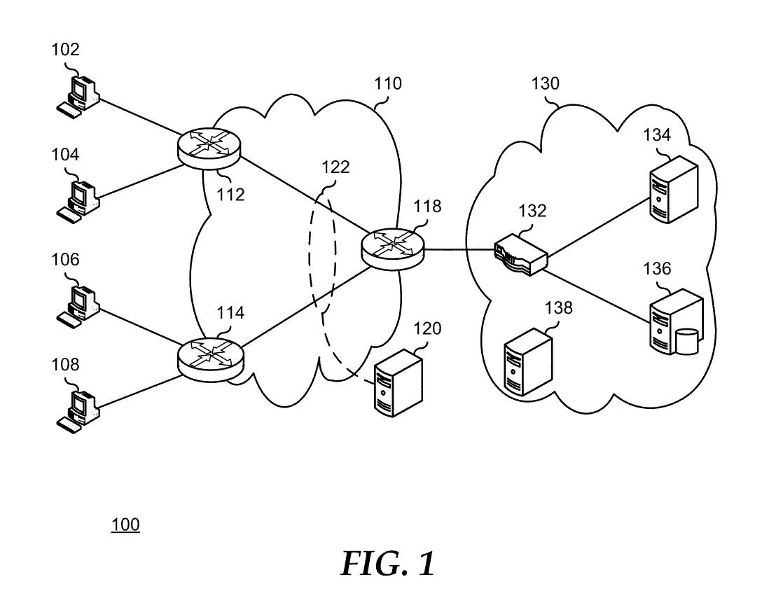

FIG. 1 illustrates an embodiment of a network 100, such as the Internet, including client systems 102, 104, 106, and 108, an autonomous system (AS) 110, a route controller 120, and a network datacenter 130. AS 110 includes edge routers 112 and 114, and a core router 118. Network datacenter 130 includes a load balancer 132, an application server 134, a database server 136, and a datacenter security system 138. AS 110 operates to provide access to the resources and functions of network datacenter 130 to client systems 102, 104, 106, and 108. For example, AS 110 can represent a routing network associated with an Internet service provider (ISP), a content delivery network (CDN), an Internet protocol television (IPTV) network, a cloud computing environment, a wireless data network or cellular telephone system, another routing network, or a combination thereof. Route controller 120 exchanges route information between edge routers 112 and 114, and core router 118. For example, edge routers 112 and 114, core router 118, and route controller 120 can communicate with each other and advertise their respective network connections through Border Gateway Protocol (BGP) or another routing protocol, as needed or desired. As such, client systems 102 and 104 gain access to network datacenter 120 through edge router 112 and core router 118, and client systems 106 and 108 gain access to the network datacenter through edge router 114 and the core router. Additionally, route controller 120 receives load information 122 for the links between edge routers 112 and 114, and core router 118. Load information 122 includes information regarding available bandwidth, bandwidth utilization, CPU utilization, memory utilization, number of transactions being served, other load information, or a combination thereof.

Network datacenter 130 operates as a centralized repository for the storage, management, and dissemination of data and information related for a particular enterprise. For example, datacenter 130 can represent a web or electronic mail (e-mail) hosting capability associated with an ISP, a cache server capacity of a CDN, a media storage and distribution operation of an IPTV network, an application and data capacity of a cloud computing environment, a data, web, application, and Voice-over-Internet Protocol (VoIP) capability of a wireless data network or cellular telephone system, another data and information storage, management, and dissemination capacity, or a combination thereof. Application server 134 represents one or more processing resources that are configured to provide a common data or information processing function, and can represent one or more stand-alone computing systems, a portion of a computing system, one or more virtual computing systems, or a combination thereof. Similarly, database server 136 represents one or more processing resources that are configured to provide a different common data or information processing function, and can represent one or more stand-alone computing systems, a portion of a computing system, one or more virtual computing systems, or a combination thereof.

Communication between network datacenter 130 and AS 110 is provided by core router 118. As such, transactions from client systems 102, 104, 106, or 108 to network datacenter 130 are routed from core router 118 to load balancer 132. Load balancer 132 operates to distribute the transactions from client systems 102, 104, 106, and 108 across the one or more instantiations of application server 134 and the one or more instantiations of database server 136 in order to ensure that the capabilities of the application server and the database server are evenly distributed between the transactions. Load balancer 132 performs a deep packet inspection on received transactions to determine what type of application or function of datacenter 130 the transactions are requesting, and determines to provide transactions to either application server 134 or database server 136 based upon the deep packet inspection of the transactions. Load balancer 132 also provides a transaction to a particular instantiation of application server 134 or to a particular instantiation of database server 136 based upon an amount of a resource of the application server or the database server that the transaction is expected to consume. For example, load balancer 134 can allocate a transaction based upon a central processing unit (CPU) load, a memory capacity, a server data bandwidth, another server resource, or a combination thereof.

Datacenter security system 138 operates to ensure that the resources of datacenter 130 are safely and securely administered, and that the resources are available when requested. As such, datacenter security system 138 represents hardware and software tools and appliances that keep the resources of datacenter 130 free from internal and external threats that prevent unauthorized access to the resources of the datacenter, and that protect the resources of the datacenter from attack. For example, datacenter security system 138 can include a firewall, a proxy, a web-based demilitarized zone (DMZ), an intrusion detection system (IDS), an intrusion prevention system (IPS), anti-virus and anti-malware protection software, spam blocking software, other hardware or software tools or appliances that ensure the safety, security and availability of the resources of datacenter 130, or a combination thereof.

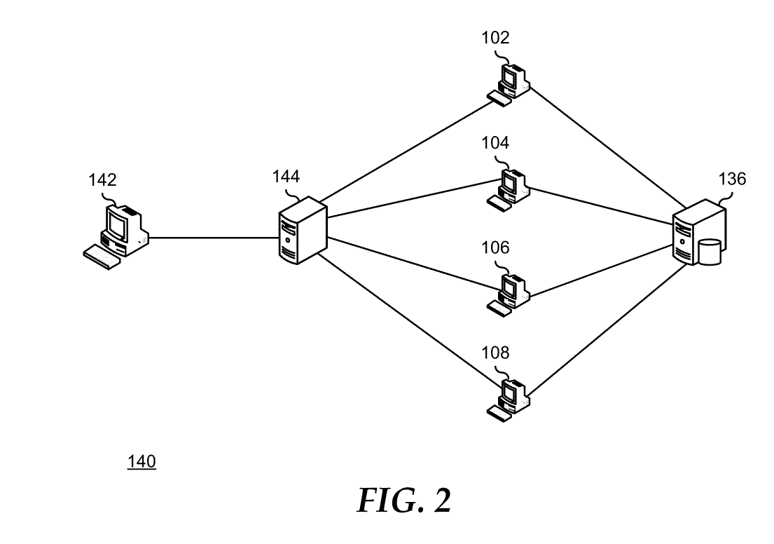

FIG. 2 illustrates an embodiment of a botnet 140, including a botnet administrator 142, also referred to as a botmaster or a bot herder, and a botnet command and control (C&C) system 144. Botnet C&C system 144 utilizes some or all of the computing resources of unsuspecting client systems 102, 104, 106, and 108, also referred to as bots or zombies, to attack a victim, here illustrated as database server 136. Client systems 102, 104, 106, and 108 are recruited into botnet 140 by downloading and running malicious software that turns over the computing resources of the infected client system to botnet C&C system 144. For example, the malicious software can be installed on client system 102, 104, 106, or 108 by a drive-by download that exploits vulnerabilities on the client system, by tricking a user into running a Trojan horse program, such as by opening an e-mail attachment, by web browsing to websites that install spyware, adware, botware, or other malicious software, by otherwise installing and running malicious software, or a combination thereof. Botnet administrator 142 then directs botnet C&C system 144 to use the aggregated computing resources of infected client systems 102, 104, 106, and 108 to perform an attack on the victim database server 136. For example, an attack can include a distributed denial-of-service (DDoS) attack, spreading of adware, spyware, botware, or other malicious software, e-mail spam, click fraud, other types of attacks, or a combination thereof. In particular, botnet administrator 142 may have the flexibility to perform different types of attacks using various combinations of infected client systems 102, 104, 106, and 108, as needed or desired.

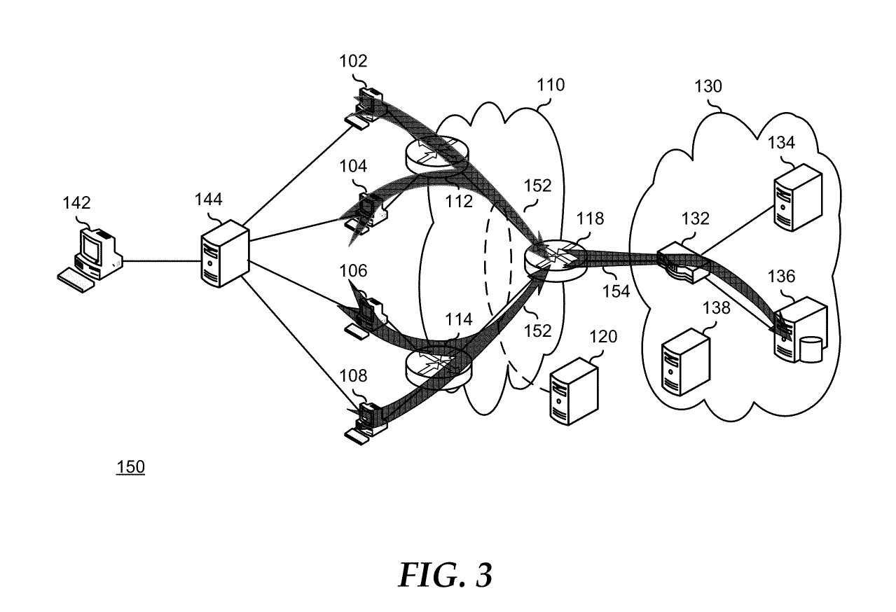

FIG. 3 illustrates an embodiment of a DDoS attack 150 on network 100 using botnet 140. Here botnet administrator 142 configures botnet C&C system 144 to direct client systems 102, 104, 106, and 108 to launch a volume DDoS attack 152, and to launch an application DDoS attack 154. Both DDoS attacks 152 and 154 are configured to consume the computational resources of one or more elements of AS 110 or network datacenter 130, to disrupt configuration information such as routing information, to disrupt network state information such as by resetting TCP sessions, to disrupt the normal communications between client systems 102, 104, 106, or 108, or a combination thereof. For example, DDoS attacks 152 and 152 can operate to overload a victim's processing devices, to over-utilize the victim's memory resources, including exceeding a stack limit, exceeding the victim's data bandwidth capacity, to trigger microcode errors or instruction sequencing errors, to exploit vulnerabilities in the victim's hardware, software, or firmware, including known processor errata, unpatched operating systems or unpatched software suites executed on the operating system, to otherwise disrupt the victim's hardware or software, or a combination thereof.

Volume DDoS attack 152 operates to consume the computational resources, disrupt configuration information, or disrupt network state information by performing a layer 3/layer 4 (L3/L4) attack on the elements of AS 110. As such, volume DDos attack 152 uses protocols and services in the Open Systems Interconnection (OSI) model layers 3 and 4. For example, volume DDoS attack 152 can include an Internet Control Message Protocol (ICMP) flood, a Transmission Control Protocol/Internet Protocol (TCP/IP) synchronize (SYN) flood or synchronize/acknowledge (SYN-ACK) flood, a TCP/IP fragmentation attack, another L3 or L4 attack, or a combination thereof. As such, volume DDoS attack 152 operates to deplete routing resources of AS 110, and particularly adversely impacts resource bottlenecks such as core router 118.

Application DDoS attack 154 operates to consume the computational resources, disrupt configuration information, or disrupt application state information by performing an application layer 7 (L7) attack on the elements of datacenter 130. As such, application DDos attack 154 uses protocols and services in the OSI model layer 7. For example, application DDoS attack 154 can include an attack on HyperText Transport Protocol (HTTP) or secure HTTP (HTTPS) applications, Domain Name System (DNS) services, other L7 protocols, other applications or functions that are accessible through L7 interactions, or a combination thereof. As such, application DDoS attack 152 operates to deplete application resources of network datacenter 120, and particularly adversely impacts application bottlenecks such as database server 136.

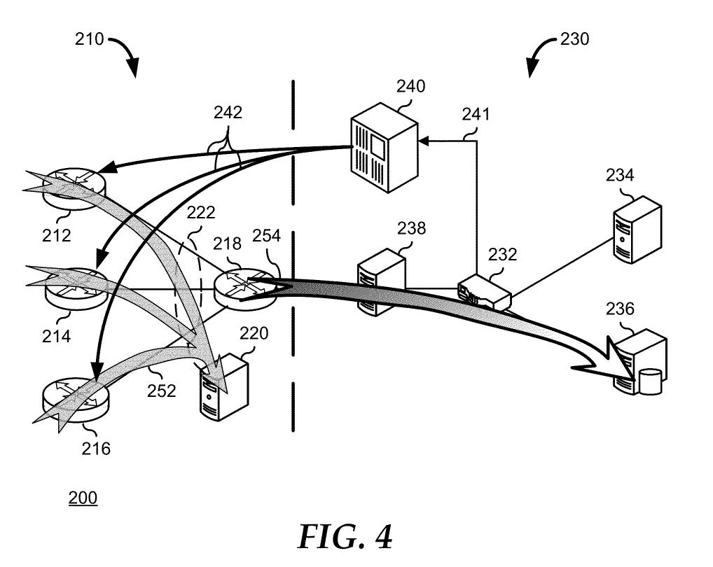

FIG. 4 illustrates an embodiment of a protected network 200, similar to network 100, including an AS 210 and a network datacenter 230. AS 210 includes edge routers 212, 214, and 216, a core router 218, and a route controller 220. Network datacenter 230 includes a load balancer 232, an application server 234, a database server 236, a datacenter security system 238, and an application DDoS mitigation appliance 240. AS 210 is similar to AS 110, and can represent a routing network associated with an Internet service provider (ISP), a content delivery network (CDN), an Internet protocol television (IPTV) network, a cloud computing environment, another routing network, a wireless data network or cellular telephone system, or a combination thereof. Route controller 220 exchanges route information between edge routers 212, 214, and 216, and core router 218, and receives load information 222 for the links between edge routers 212, 214, and 216, and core router 218. Route controller 220 also operates to mitigate L3/L4 DDoS attacks, as described below.

Network datacenter 230 is similar to network data center 130 and can represent a web or electronic mail (e-mail) hosting capability associated with an ISP, a cache server capacity of a CDN, a media storage and distribution operation of an IPTV network, an application and data capacity of a cloud computing environment, a data, web, application, and VoIP capability of a wireless data network or cellular telephone system, another data and information storage, management, and dissemination capacity, or a combination thereof. Application server 234 and database server 236 are similar to application server 134 and database server 136, respectively.

Communication between network datacenter 230 and AS 210 is provided by core router 218 such that transactions from client systems are routed from core router 218 to load balancer 232 through datacenter security system 238. Load balancer 232 operates to perform a deep packet inspection on received transactions to determine what type of application or function of datacenter 230 the transactions are requesting, to determine to provide transactions to either application server 234 or application server 236 based upon the deep packet inspection of the transactions, and to distribute the transactions from the client systems across one or more instantiations of application server 234 and one or more instantiations of database server 236, and to direct transactions based upon an amount of a resource of the application server or the database server that the transactions are expected to consume. Datacenter security system 238 is similar to datacenter security system 138, and can represent a firewall, a proxy, a web-based demilitarized zone (DMZ), an intrusion detection system (IDS), an intrusion prevention system (IPS), anti-virus and anti-malware protection software, spam blocking software, other hardware or software tools or appliances that ensure the safety, security and availability of the resources of datacenter 230, or a combination thereof.

Protected network 200 is illustrated as experiencing a volume DDoS attack 252, and an application DDoS attack 254. Volume DDoS attack 252 operates similarly to volume DDoS attack 152 to consume the computational resources, disrupt configuration information, or disrupt network state information within protected network 200 by performing an L3/L4 attack. Because route controller 220 is situated in AS 210, the route controller operates to mitigate volume DDoS attack 252. In particular, route controller 220 is in a position to easily detect increases in the types of network traffic associated with L3 and L4 attacks, because transaction routing in AS 210 is based upon L3 and L4 protocols. For example, route controller 220 can detect an unusual increase in the number of ICMP transactions associated with an ICMP flood attack, the number of TCP/IP SYN transactions associated with a TCP/IP SYN flood, the number of transactions that have fragmented TCP or IP packets associated with a TCP/IP fragmentation attack, or other indicators associated with other L3 or L4 attacks, or a combination thereof. When route controller 220 detects volume DDoS attack 252, the route controller operates to minimize or eliminate the effects of the attack. For example, route controller 220 can provide data rate limits to the most affected edge routers 212, 214, or 216 aimed at limiting the number of transactions of the type associated with volume DDoS attack 252, can provide filters and redirects to null routers such that the traffic associated with the volume DDoS attack is dropped from AS 210, or other actions that are known in the art to mitigate L3/L4 DDoS attacks, as needed or desired.

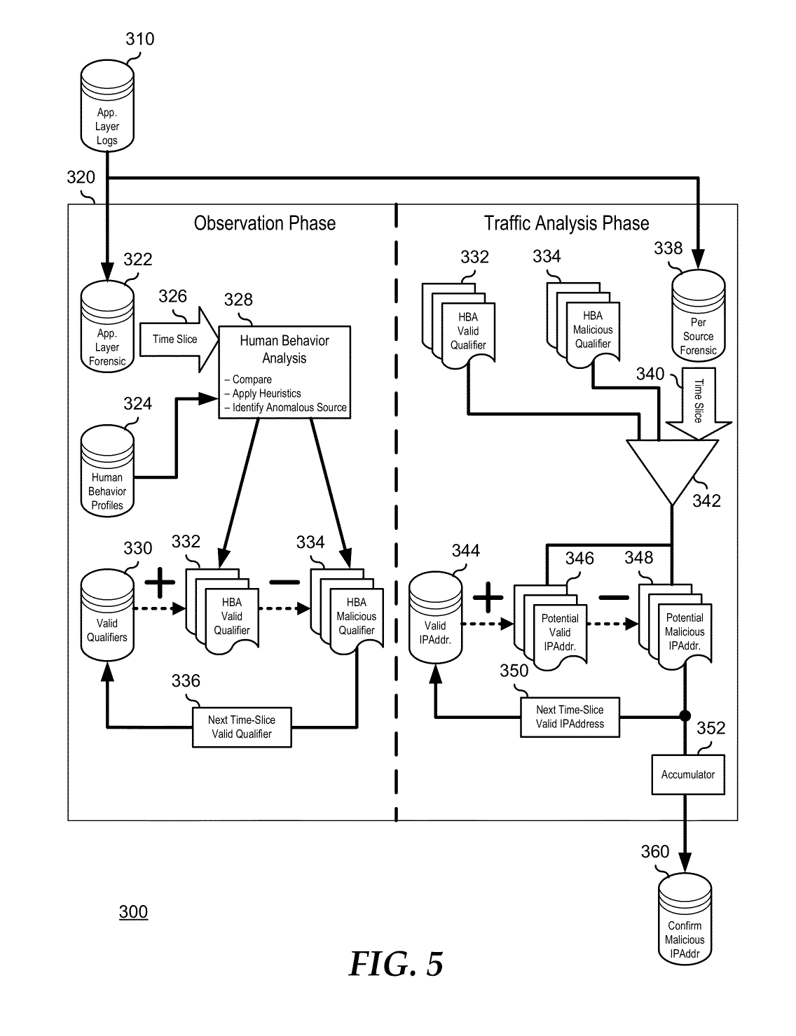

Application DDoS attack 254 operates similarly to application DDoS attack 154 to consume the computational resources, disrupt configuration information, or disrupt application state information by performing an L7 attack on the elements of datacenter 230. Application DDoS mitigation appliance 240 is situated in datacenter 230 to mitigate application DDoS attack 254. In particular, application DDoS mitigation appliance 240 is in a position to easily detect increases in the types of network traffic associated with L7 attacks, because of the deep packet inspection performed by load balancer 232 that determines the type of L7 application to which the transactions are targeted. More particularly, application DDoS mitigation appliance 230 receives application layer logs 241, and based upon an evaluation of the information included in the application layer logs, determines a set of confirmed malicious IP addresses 242 that are exported to edge routers 212, 214, and 216, such that the edge routers filter or redirect transactions that are associated with application DDoS attack 254. The evaluation performed by application DDoS mitigation appliance 240 on application layer logs 241 and the determination of confirmed malicious IP addresses 242 is based upon a human behavior analysis (HBA) module which will be further described below with respect to FIG. 5.

Note that it is not necessary that application layer logs 241 are provided by load balancer 232, and that, in a particular embodiment, the application layer logs are provided by datacenter security system 238, another element of protected network 200 that operates to provide application layer logs, or a combination thereof. Moreover, note that confirmed malicious IP addresses 242 need not be provided solely to edge routers 212, 214, and 216, and that, in another embodiment, the confirmed malicious IP addresses are provided to core router 218, to datacenter security system 238, to load balancer 232, to application server 234, to database server 236, to another element of protected network 200 that operates to filter or redirect transactions that are associated with application DDoS attack 254, or a combination thereof.

FIG. 5 illustrates an embodiment of an application DDoS mitigation appliance 300 similar to application DDoS mitigation appliance 240, including application layer log repository 310, an HBA module 320, and a confirmed malicious IP address repository 360. Application DDoS mitigation appliance 300 receives application layer log information, and based upon an evaluation of the information, determines a set of confirmed malicious IP addresses that are exported to the edge routers of a network associated with the application DDoS mitigation appliance, in order to filter or redirect transactions that are associated with an application DDoS attack. Application layer log repository 310 receives and stores application layer log information from another device of a protected datacenter similar to protected datacenter 230, such as from a load balancer similar to load balancer 232, a server similar to application server 234 or database server 236, a datacenter security system similar to datacenter security system 238, another device of a protected datacenter, or a combination thereof. The application layer log information represents information generated in a datacenter that relates to the L7 activity that occurs in the datacenter, including indicators that characterize the activity, based upon various fields included in the L7 transactions that are handled by the datacenter. For example, the application layer log information can include information related to the source of a transaction or whether or not the source of the transaction is an authenticated user, to a Universal Resource Indicator (URI) requested by a transaction, to a user agent or browser associated with a transaction, to an operating system associated with the source of a transaction, to an HTTP referrer associated with a transaction, to a timestamp associated with a transaction, to a search engine or search string associated with a transaction, to HTTP errors generated in response to a transaction, to other information related to a transaction, or to a combination thereof.

In a particular embodiment, the application layer log information is received and stored by application layer log repository 310 on an ongoing basis. Here, the application layer log information is sent to application layer log repository 310 when the application layer log information is generated. In another embodiment, the application layer log information is received and stored by application layer log repository 310 on a periodic basis. In this embodiment, the application layer log information is periodically sent to application layer log repository 310, such as after a predetermined amount of time, when a predetermined number of application layer logs are generated, or on another periodic basis. In yet another embodiment, application DDoS mitigation appliance 300 requests the application layer log information, or polls one or more devices that generate the application layer log information. An example of application layer log information that is stored in application layer log repository 310 includes logs generated by an Apache HTTP Server, an IBM HTTP Server, an Nginx Server, an Oracle HTTP Server, another web server or L7 logging device or application, or a combination thereof.

HBA module 320 provides a two-phase operation including an observation phase and a traffic analysis phase. The observation phase includes an application layer forensic repository 322, an human behavior profile repository 324, a forensic time slice module 326, an HBA engine 328, a valid qualifier repository 330, a list of HBA valid qualifiers 332, a list of HBA malicious qualifiers 334, and a next time slice valid qualifier module 336. The traffic analysis phase includes HBA valid qualifiers 332, HBA malicious qualifiers 334, a per-source forensic repository 338, a per-source forensic time slice module 340, a comparison module 342, a valid IP address module 344, a list of potential valid IP addresses 346, a list of potential malicious IP addresses 348, a next time slice valid IP addresses module 350, and an accumulator module 352. In the observation phase, the application layer log information is retrieved from application layer log repository 310, and is parsed into application layer forensic information that is stored in application layer forensic repository 322. The application layer log information is parsed by reference to any of the various fields included in the L7 transactions that are handled by the datacenter, or by a combination of the various fields. For example, the application layer log information can be parsed by sources of a transaction, authenticated sources of transactions, URIs requested, user agent or browser types, operating systems, HTTP referrers, timestamps, search engines or search strings, transactions associated with HTTP errors, other information types included in application layer log repository 310, or a combination thereof.

Human behavior profile repository 324 includes profile information related to the types of transactions that are likely to be initiated by a human or otherwise legitimate users of the network, and the types of transactions that are likely to be initiated by bots or other infected client systems. The profile information includes entries that correlate particular transaction with a likelihood of having a human user associated with the transaction, and other entries that correlate that same particular transaction or similar transactions with a likelihood of being initiated by a bot, and therefore potentially being a malicious transaction. For example, a single request for a web page associated with a particular URL may be deemed to be valid, while a rapid succession of requests for the same page, or for similar pages, such as when content in a website is posted on successively numbered web pages or dated web pages, may be likely to be malicious, particularly when the requests are repeated over a short time duration. The profile information also includes entries that correlate particular attributes of a transaction with a likelihood of being associated with a human user, and other entries that correlate the same or similar attributes with a likelihood of being initiated by a bot. For example, benign transactions are likely to have a random assortment of HTTP referrers, while potentially malicious transactions can have a non-random HTTP referrer, such as an offensive phrase, a joke or pun, or an otherwise suspicious HTTP referrer. Here, the profile information can include a list of known or suspected malicious HTTP referrers.

The profile information also includes entries that correlate particular combinations of attributes of a transaction with a likelihood of being associated with a human user, and other entries that correlate the same or similar combinations of attributes with a likelihood of being initiated by a bot. For example, benign transactions are likely to have consistent attributes, such as when a transaction is associated with a mobile device operating system and a mobile device browser, and the transaction is for a web site's mobile web page, while potentially suspect transactions may have inconsistent attributes such as when a transaction is associated with a mobile device operating system and a mobile device browser, but the transaction is for a web site's standard HTTP web page, instead of its mobile web page. Further, the profile information includes entries that correlate particular combinations of transactions with a likelihood of being associated with a human user, and other combinations of transactions with a likelihood of being initiated by a bot. For example, in response to an HTTP GET request, a website will provide a response that includes a HyperText Markup Language (HTML) file. The HTML file includes references to other content, such as style sheets, Java scripts, icons, images and graphics interchange format (GIF) files, links to other content, such as adspace content, and other content or information. Benign transactions are likely to follow up the initial HTTP GET request with requests for the other content referred to in the HTML file, while potentially suspect transactions may include the HTTP GET request but fail to follow up to request the some or all of the other content.

The above examples of profile information included in human behavior profile repository 324 are not exhaustive, and are meant to be illustrative of different types of profile information that can be included in the human behavior profile repository. Indeed, it is in the nature of application DDoS attacks and those who create them, that the landscape is constantly changing. As such, it is expected that the profile information included in human behavior profile repository 324 is changing accordingly, in order to adapt to the changing landscape of application DDoS attacks. In a particular embodiment, application DDoS mitigation appliance 300 is associated with a network administrative structure, including technicians and other personnel, who correlate certain types of transactional activity with valid transactions, and other transactional activity with potentially malicious transactions, and that provide updates to the profile information included in human behavior profile repository 324, in order to meet the changing landscape of application DDoS attacks. In another embodiment, the profile information is automatically generated based upon collected data from the datacenter associated with application DDoS mitigation appliance 300. For example, when a website is hosted at the datacenter, the normal traffic for the website can be tracked, and the information gathered from the tracking can be used to create profiles associated with valid traffic for the website, for example by applying a statistical analysis to the normal traffic, and then flagging statistically dissimilar transaction patterns as potentially suspect. Similarly, a server associated with a particular service or function of the datacenter can experience a heavy load on a particular resource, such as a CPU or memory, and the datacenter can respond by tracking the traffic associated with the service or function in order to create a profile indicating that the type of traffic associated with the heavy load is potentially malicious. In yet another embodiment, the profile information included in human behavior profile repository 324 is self modifying, in order to adapt to the changing threat landscape.

Forensic time slice module 326 operates to periodically retrieve the most recent application layer forensic information from application layer forensic repository 322. In a particular embodiment, the most recent application layer forensic information is determined based upon a time slice that represents a predetermined amount of time, such as the amount of application layer forensic information that is received each half a second, each second, each minute, or another predetermined amount of time. In another embodiment, the most recent application layer forensic information is determined based upon a processing capacity of HBA module 320, such as a block of 100 application layer forensic information entries, 1000 entries, or another number of entries.

Human behavior analysis engine 328 receives the most recent application layer forensic information from forensic time slice module 326, and evaluates the most recent application layer forensic information based upon the human behavior profiles from human behavior profile repository 324. Here, when the profile information includes entries that correlate a particular transaction or transactions with a likelihood of having an associated human user, and other entries that correlate that same particular transaction or similar transactions with a likelihood of being malicious, human behavior analysis engine 328 operates to compare the most recent application layer forensic information to see if any of the transactions demonstrate a pattern associated with a human user, or a pattern of repeated transactions, or repeated similar transactions that is associated with a bot.

For example, given an human behavior profile from human behavior profile repository 324 indicating that a single request for a web page associated with a particular URL may be deemed to be valid, and the presence in the most recent application layer forensic information of a single transaction requesting the URL “www.blacklotus.net,” HBA engine 328 can create an HBA valid qualifier associating a single request with the URL “www.blacklotus.net,” and place the HBA valid qualifier in HBA valid qualifier list 332 Further, given an human behavior profile from human behavior profile repository 324 indicating that a rapid succession of requests for the same page, or for similar pages may be likely to be malicious when repeated over the duration of a time slice of forensic time slice module 326, and the presence in the most recent application layer forensic information of a string of transactions requesting the URL “www.blacklotus.net,” or a string of transactions requesting the URL “www.blacklotus.net/1.pdf,” “www.blacklotus. net/2.pdf,” “www.blacklotus.net/3.pdf,” and etc., HBA engine 328 can create an HBA malicious qualifier associating a string of transactions with the URL “www.blacklotus.net.” or with “www.blacklotus.net/1.pdf,” “www.blacklotus.net/2.pdf,” “www.blacklotus.net/3.pdf,” and etc., and place the HBA malicious qualifier in HBA malicious qualifier list 334. Note that the fact that “www.blacklotus.net” appears in both HBA valid qualifier list 332 HBA malicious qualifier list 324 is not necessarily a contradiction because, in the course of a DDoS attack, there may be valid requests for the contents of “www.blacklouts.net,” and both valid requests and malicious requests will need to be handled in the traffic analysis phase, as described below.

Further, when the profile information includes entries that correlate particular attributes of a transaction with a likelihood of being associated with a human user, and other entries that correlate the same or similar attributes with a likelihood of being initiated by a bot, human behavior analysis engine 328 operates to compare the most recent application layer forensic information to see if any of the transactions include the particular attributes that demonstrate a pattern associated with a human user, or a pattern that is associated with a bot. For example, given an human behavior profile indicating that potentially malicious transactions can include a non-random HTTP referrer, and the presence in the most recent application layer forensic information of a transaction having an offensive HTTP referrer, HBA engine 328 can create an HBA malicious qualifier associated with the offensive HTTP referrer, and place the HBA malicious qualifier in HBA malicious qualifier list 334.

Also, when the profile information includes entries that correlate particular combinations of attributes of a transaction with a likelihood of being associated with a human user, and other entries that correlate the same or similar combinations of attributes with a likelihood of being initiated by a bot, human behavior engine 328 operates to compare the most recent application layer forensic information to see if any of the transactions include the combination of attributes that demonstrate a pattern associated with a human user, or a pattern that is associated with a bot. For example, given an human behavior profile indicating that potentially malicious transactions can include inconsistent attributes such as when a transaction is associated with a mobile device operating system and a mobile device browser, but the transaction is for a web site's standard HTTP web page, instead of the web site's mobile web page, and the presence in the most recent application layer forensic information of a transaction that is associated with a mobile device operating system and a mobile device browser, but that is for a web site's standard HTTP web page, HBA engine 328 can create an HBA malicious qualifier associated with the inconsistent transaction, and place the HBA malicious qualifier in HBA malicious qualifier list 334.

Moreover, when the profile information includes entries that associate a particular combination of transactions with a likelihood of being initiated by a bot, human behavior engine 328 operates to compare the most recent application layer forensic information to see if any of the transactions include the combination of transactions that demonstrate a pattern associated with a human user, or a pattern that is associated with a bot. For example, given an human behavior profile indicating that potentially malicious transactions can include an HTTP GET request without any follow up requests for some or all of the other content associated with the GET request, and the presence in the most recent application layer forensic information of a GET request for the contents of a particular website from a particular source that is not accompanied by follow up requests from that same source for the other content of the website, HBA engine 328 can create an HBA malicious qualifier associated with the website, and place the HBA malicious qualifier in HBA malicious qualifier list 334. Note that, as with human behavior profile repository 324, the above examples of the workings of HBA engine 328 are not exhaustive, and are meant to be illustrative of different types of activities and functions of HBA engine 328.

After HBA engine 328 places the HBA valid qualifiers in HBA valid qualifier list 332 and the HBA malicious qualifiers in HBA malicious qualifier list 334, the qualifier lists are processed to maintain valid qualifier repository 330. Valid qualifier repository 330 includes the HBA valid qualifiers generated by HBA engine 328 in previous time slices. In a particular time slice, the HBA valid qualifiers are added to the valid qualifiers from valid qualifier repository 330, thereby aggregating the known valid qualifiers. From the known valid qualifiers are subtracted the HBA malicious qualifiers from HBA malicious qualifiers list 334, and next time slice valid qualifier module 336 provides the resulting valid qualifiers to valid qualifier repository 330 for use in the next time slice. In this way, previously valid qualifiers that may be exploited in new application DDoS attacks are removed from valid qualifier repository 330 in future time slices.

While the observation phase processing described above is occurring, new application layer log information is retrieved from application layer log repository 310, and is parsed into new application layer forensic information that is stored in application layer forensic repository 322. At the next time slice, forensic time slice module 326 retrieves the new application layer forensic information, and the observation phase is repeated for the next time slice.

In the traffic analysis phase, the application layer log information is retrieved from application layer log repository 310, and is parsed into per-source forensic information that is stored in per-source forensic repository 338. The per-source forensic information is parsed by reference to the sources of the transactions that are handled by the datacenter, such that each source of a transaction is listed with each type of transaction that is issued by the source. Per-source forensic time slice module 340 operates to periodically retrieve the most recent per-source forensic information from per-source forensic repository 338. In a particular embodiment, the most recent per-source forensic information is determined based upon a time slice that represents a predetermined amount of time, such as the amount of application layer forensic information that is received each half a second, each second, each minute, or another predetermined amount of time. In another embodiment, the most recent per-source forensic information is determined based upon a processing capacity of HBA module 320, such as a block of 100 application layer forensic information entries, 1000 entries, or another number of entries.

Comparison module 342 receives the time sliced per-source forensic information from per-source forensic time slice module 340 and compares the time sliced per-source forensic information with the HBA valid qualifiers from HBA valid qualifier list 332 and with the HBA malicious qualifiers from HBA malicious qualifier list 334. As such, the transactions that are associated with a given transaction source are compared with the HBA valid qualifier list 332 to see if the transactions match the parameters provided by the HBA valid qualifier. If the transactions match, then the source is deemed a potentially valid source, and the IP address for the source is provided to potential valid IP address list 346. Similarly, the transactions that are associated with another transaction source are compared with the HBA malicious qualifier list 334 to see if the transactions match the parameters provided by the HBA malicious qualifier. If the transactions match, then the source is deemed a potentially malicious source, and the IP address for the source is provided to potential malicious IP address list 348.

After comparison module 342 places the potential valid IP addresses in potential valid IP address list 346 and the potential malicious IP addresses in potential malicious IP address list 348, the address lists are processed to maintain valid IP address repository 344. Valid IP address repository 344 includes the valid IP addresses generated by comparison module 342 in previous time slices. In a particular time slice, the potentially valid IP addresses are added to the valid IP addresses from valid IP address repository 344, thereby aggregating the known valid IP addresses. From the known valid IP addresses are subtracted the potential malicious IP addresses from potential malicious IP address list 348, and next time slice valid IP address module 350 provides the resulting valid IP addresses to valid IP address repository 344 for use in the next time slice. In this way, previously valid IP addresses that may be exploited in new application DDoS attacks are removed from valid IP address repository 344 in future time slices. Potential malicious IP address list 348 is provided to confirmed malicious IP address repository 360 via accumulator 352. Accumulator 352 operates as a filter on potentially malicious IP address list 348, so that transactions which can appear malicious from the perspective of a single time slice, but that are in fact not malicious, are excluded from the confirmed malicious IP address 360. For example, a transaction from a particular source IP address can issue a GET request can be evaluated in a first time slice, and subsequent requests for the additional content can arrive in a subsequent time slice. As such, accumulator 352 provides for a settling time, before potential malicious IP address list 348 is provided to confirmed malicious IP address repository 360.

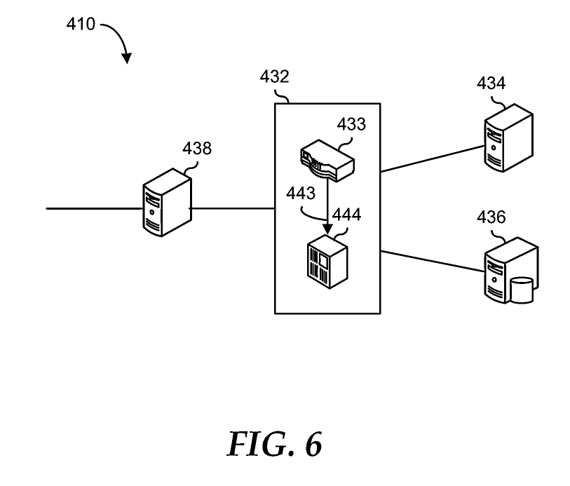

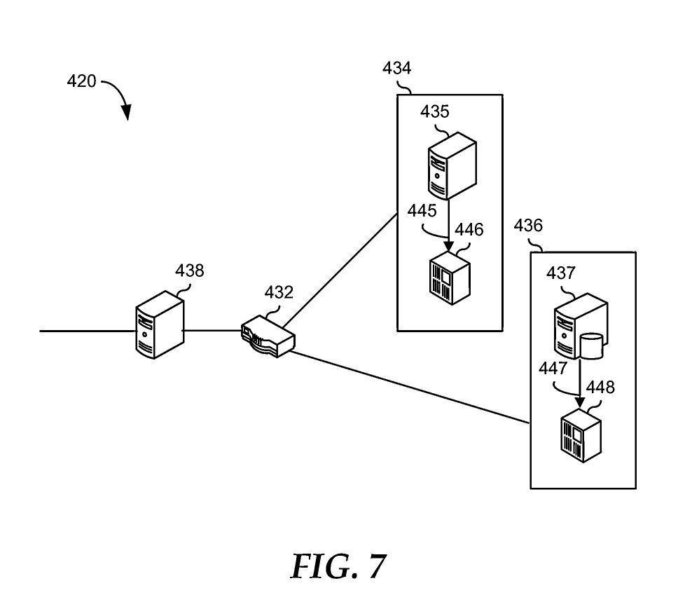

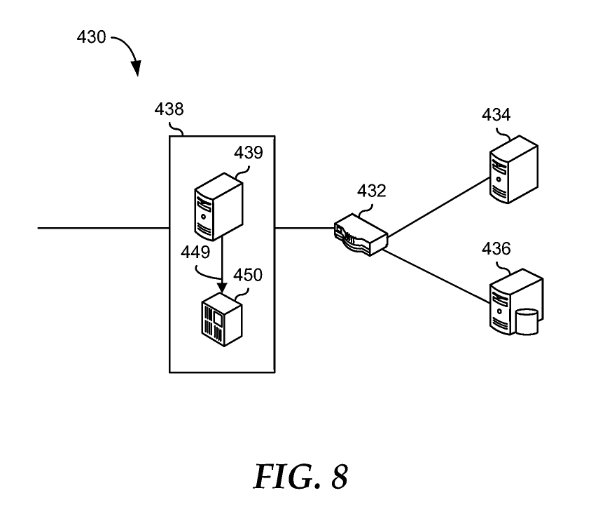

FIGS. 6-8 illustrate embodiments of different usage models for providing an application DDoS attack mitigation appliance in a protected network similar to protected network 200. FIG. 6 illustrates datacenter 410 similar to datacenter 230, including load balancer 432, application server 434, database server 436, and datacenter security system 438. Load balancer 432 includes a load balancer module 433 and an application DDoS attack mitigation module 444. In operation, load balancer module 433 performs a deep packet inspection and provides application layer logs 443 to application DDoS attack module 444, and the application DDoS module determines the set of confirmed malicious IP addresses that are exported to the edge routers of the protected network. FIG. 7 illustrates datacenter 420 similar to datacenter 410. Here application server 434 includes an application server module 435 and an application DDoS attack mitigation module 446, and database server 436 includes a database server module 437 and an application DDoS attack mitigation module 448. In operation, application server module 435 and database server module 437each perform deep packet inspections on the transactions received from load balancer 432. Application server module 435 provides application layer logs 445 to application DDoS attack module 446, and database server module 437 provides application layer logs 447 to application DDoS attack module 448. Application DDoS modules 446 and 448 each determine a portion of the set of confirmed malicious IP addresses that are exported to the edge routers of the protected network. FIG. 8 illustrates datacenter 430 similar to datacenter 410. Here datacenter security system 438 includes a datacenter security module 439 and an application DDoS attack mitigation module 450. In operation, datacenter security module 439 performs deep packet inspections on the transactions received from AS 210 and provides application layer logs 449 to application DDoS attack module 450, and application DDoS module 450 determines the set of confirmed malicious IP addresses that are exported to the edge routers of the protected network.

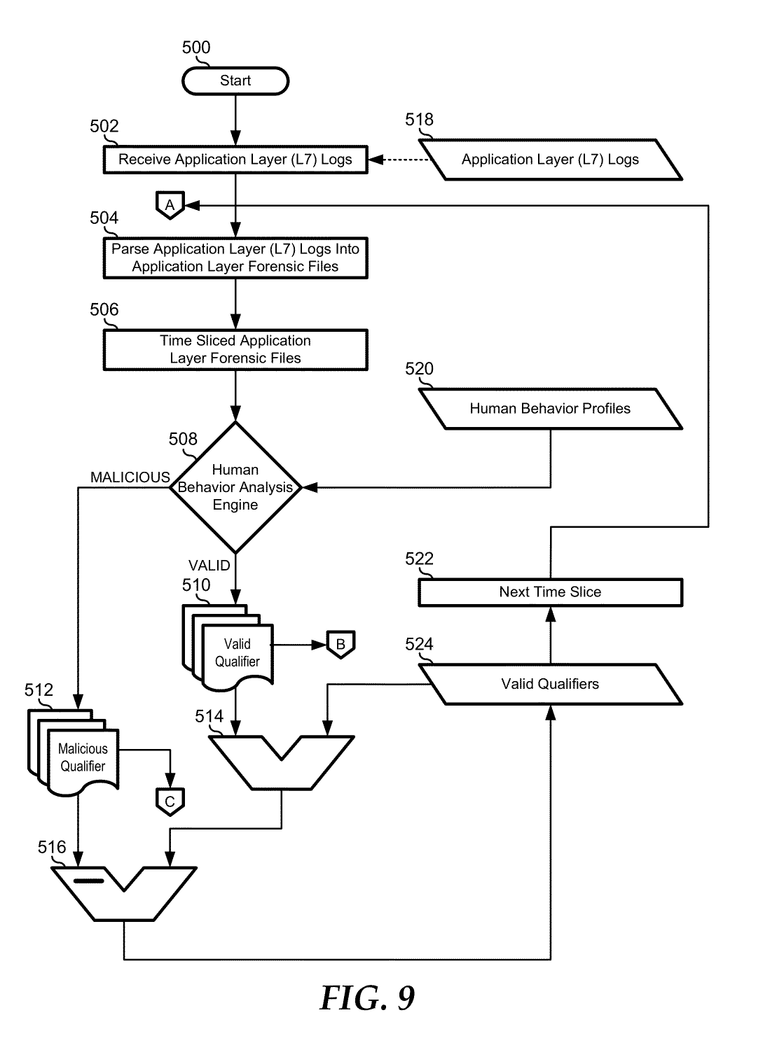

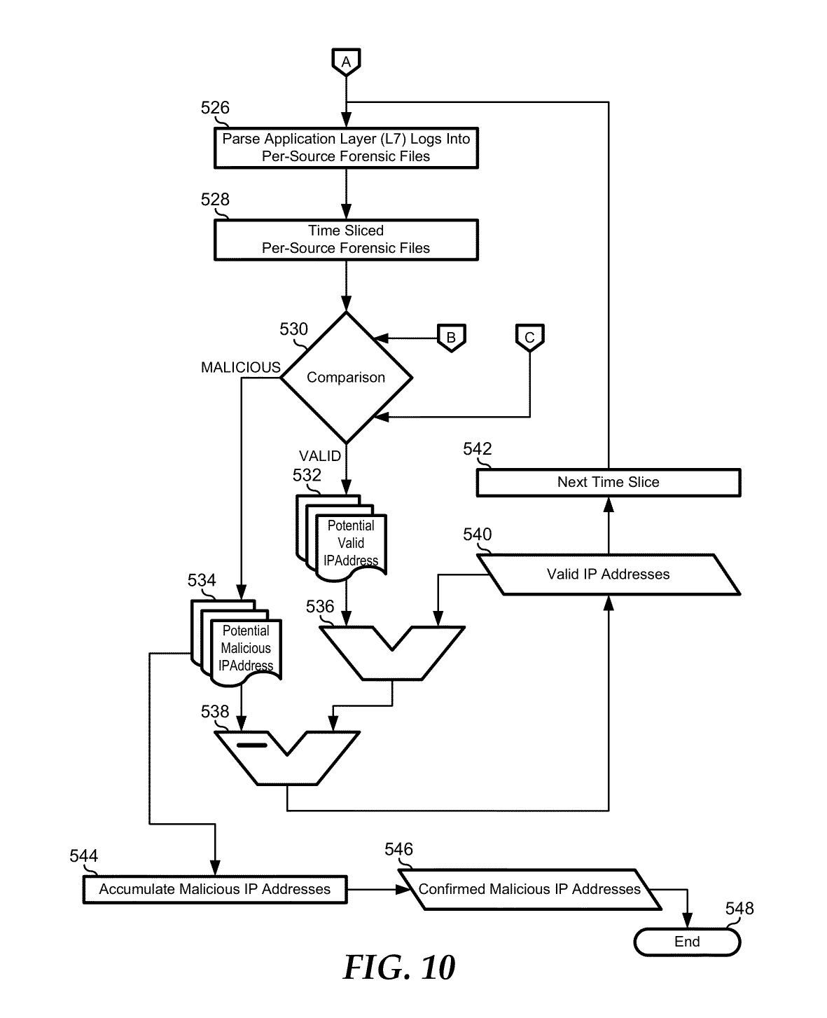

FIGS. 9 and 10 illustrate a method for mitigating distributed denial of service attacks in a communications network starting at block 500. In particular, FIG. 9 illustrates the method as it occurs in an observation phase, and FIG. 10 illustrates the method as it occurs in a traffic analysis phase. Application layer (L7) logs 518 are received in block 502. For example, application layer log repository 310 can receive and store application layer log information from a device of a protected datacenter, including information generated in a datacenter that relates to the L7 activity that occurs in the datacenter. The application layer (L7) logs are parsed into application layer forensic files in block 504. Here, the application layer log information can be retrieved from application layer log repository 310, and parsed into application layer forensic information that is stored in application layer forensic repository 322. The application layer forensic files are time sliced in block 506. For example, forensic time slice module 326 can periodically retrieve the most recent application layer forensic information from application layer forensic repository 322.

The application layer forensic files from block 506 and human behavior profiles 520 are received and compared by a human behavior analysis engine to determine if a transaction or sequence of transactions represents a valid qualifier or a malicious qualifier in comparison block 508. For example, human behavior analysis engine 328 can receive the most recent application layer forensic information from forensic time slice module 326, and evaluate the most recent application layer forensic information based upon the human behavior profiles from human behavior profile repository 324, where human behavior profile repository 324 includes profile information related to the types of transactions that are likely to be initiated by a human or otherwise legitimate users of the network, and the types of transactions that are likely to be initiated by bots or other infected client systems. If a transaction or sequence of transactions represents a valid qualifier, the “VALID” branch of comparison block 508 is taken, and a valid qualifier is added to valid qualifier list 510. If a transaction or sequence of transactions represents a malicious qualifier, the “MALICIOUS” branch of comparison block 508 is taken, and a malicious qualifier is added to malicious qualifier list 512. For example, the profile information from application profile repository 324 includes entries that correlate a particular transaction or transactions with a likelihood of having an associated human user, and other entries that correlate that same particular transaction or similar transactions with a likelihood of being malicious, and human behavior analysis engine 328 can operates to compare the most recent application layer forensic information from time slice module 326 to see if any of the transactions demonstrate a pattern associated with a human user, or a pattern of repeated transactions, or repeated similar transactions that is associated with a bot, and can add a corresponding valid qualifier in HBA valid qualifier lit 332, or a corresponding malicious qualifier in HBA malicious qualifier list 334.

The valid qualifiers from valid qualifier list 514 are summed together with the contents of a valid qualifier repository 524 in summing block 514. The malicious qualifiers from malicious qualifier list 512 are subtracted from the output of summing block 514 in summing block 516. The output of summing block 516 is provided to valid qualifier repository 524 such that the valid qualifiers are updated for subsequent time slices. For example, HBA valid qualifier list 332 and HBA malicious qualifier list 334 can be processed to maintain valid qualifier repository 330. A next time slice is initiated in block 522, and the method returns to block 504 where the next time slice of application layer logs are parsed into application layer forensic files.

The application layer logs received in block 502 are parsed into application layer per-source forensic files in block 526. For example, the application layer log information retrieved from application layer log repository 310 can be parsed into per-source forensic information that is stored in per-source forensic repository 338. The application layer per-source forensic files are time sliced in block 528. For example, per-source forensic time slice module 340 can periodically retrieve the most recent per-source forensic information from per-source forensic repository 338.

The application layer per-source forensic files from block 528, the valid qualifiers from valid qualifier list 510, and the malicious qualifiers from malicious qualifier list 512 are received and compared to determine if transactions associated with a particular source IP address represents a valid IP address or a malicious IP address in comparison block 530. For example, comparison module 342 can receive the time sliced per-source forensic information from per-source forensic time slice module 340 and compare the time sliced per-source forensic information with the HBA valid qualifiers from HBA valid qualifier list 332 and with the HBA malicious qualifiers from HBA malicious qualifier list 334. The transactions that are associated with a given transaction source can be compared with the HBA valid qualifier list 332 to see if the transactions match the parameters provided by the HBA valid qualifier list. Further, the transactions that are associated with another transaction source can be compared with the HBA malicious qualifier list 334 to see if the transactions match the parameters provided by the HBA malicious qualifier list. If the transactions match the parameters provided by valid qualifier list 510, the “VALID” branch of comparison block 530 is taken, and a potential valid IP address is added to potential valid IP address list 532. If the transactions match the parameters provided by malicious qualifier list 512, then the source is deemed a potentially malicious source, and the IP address for the source is provided to potential malicious IP address list 534.

The valid IP addresses from potential valid IP address list 532 are summed together with the contents of a valid IP address repository 540 in summing block 536. The malicious IP addresses from potential malicious IP address list 534 are subtracted from the output of summing block 536 in summing block 538. The output of summing block 538 is provided to valid IP address repository 540 such that the valid IP addresses are updated for subsequent time slices. A next time slice is initiated in block 542, and the method returns to block 526 where the next time slice of application layer logs are parsed into application layer per-source forensic files. The malicious IP addresses from potential malicious IP address list 534 are accumulated in block 544. For example, potential malicious IP address list 348 can be provided to accumulator 352, so that transactions which can appear malicious from the perspective of a single time slice, but that are in fact not malicious, are excluded from the confirmed malicious IP address 360. The confirmed malicious IP addresses are provided to a confirmed malicious IP address repository 546, and the method ends in block 548.

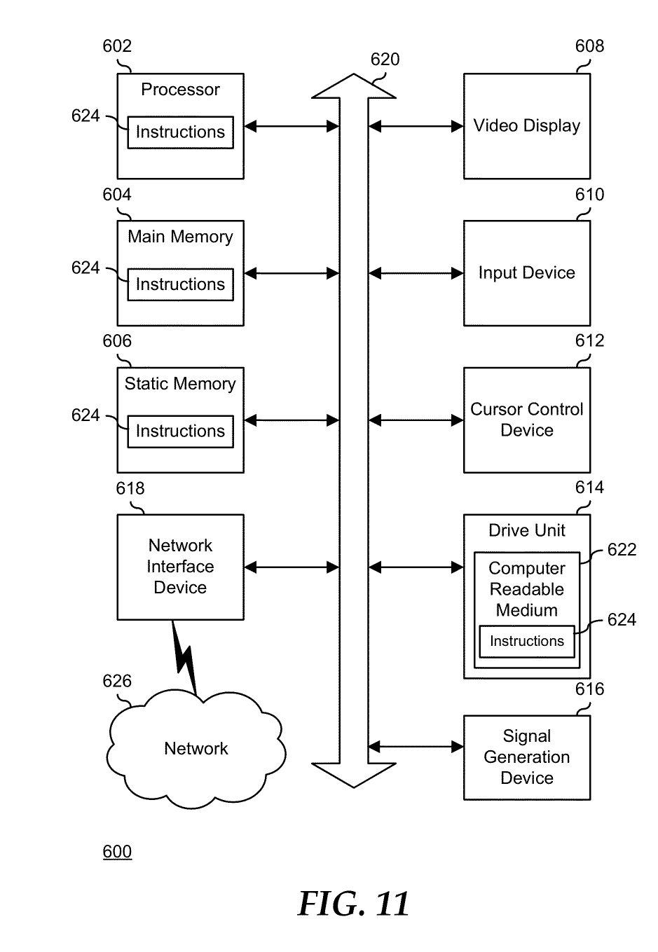

FIG. 11 illustrates an embodiment of a general computer system 600. The computer system 600 includes instructions that are executed to cause the computer system to perform any one or more of the methods or functions disclosed herein. Computer system 600 can operate as a standalone device or can be connected, such as by using a network, to other computer systems or peripheral devices. Computer system 600 can operate as a server or as a client user computer in a server-client user network environment, or as a peer computer system in a peer-to-peer (or distributed) network environment. Computer system 600 can also be implemented as or incorporated into various devices, such as a personal computer (PC), a tablet PC, a set-top box(STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing instructions (sequential or otherwise) that specify actions to be taken by that machine. In a particular embodiment, computer system 600 can be implemented using electronic devices that provide voice, video, or data communication. Further, while computer system 600 is illustrated as a single item, the term “system” shall also be taken to include any collection of systems or sub-systems that individually or jointly execute a set of, or multiple sets of instructions to perform one or more of the methods or functions disclosed herein.

Computer system 600 includes a processor 602, a main memory 604, a static memory 606, a video display unit 608, an input device 610, a cursor control device 612, a disk drive unit 614, a signal generation device 616, and a network interface device 618, that communicate with each other via a bus 620. Processor 602 represents a central processing unit (CPU), a graphics processing unit (GPU), another processing device, or a combination thereof. Main memory 604 represents a random access memory, such as a static RAM, a dynamic RAM or another type of RAM or system main memory, or a combination thereof. Static memory 606 represents a non-volatile RAM, read-only memory (ROM) such as an EEPROM, solid state memory, another static memory, or a combination thereof. Video display unit 608 represents a liquid crystal display (LCD), an organic light emitting diode (OLED), a flat panel display, a solid-state display, another display device, or a combination thereof. Input device 610 represents a keyboard, and cursor control device 612 represents a mouse. Alternatively, input device 610 and cursor control device 612 can be combined with video display unit 608 in the form of a touchpad or touch sensitive screen. Disk drive device 614 represents an information storage device including a disk drive, a solid state drive (SSD), an external hard drive, another information storage device, or a combination thereof. Signal generation device 616 represents a speaker, a remote control unit, another device, or a combination thereof. Network interface device 618 communicates with a network 626. Disk drive device 614 includes a computer-readable medium 622 for storing one or more sets of instructions 624. Additionally, main memory 604 and static memory 606 store one or more additional sets of instructions 624. The sets of instructions 624 represent programs, software, firmware, machine-executable code, other instructions, or a combination thereof. Also, instructions 624 can be embedded in a device of computer system 600. In a particular embodiment, instructions 624 represent one or more of the methods or logic as described herein. Processor 602 operates to execute instructions 624 to perform one or more of the methods or logic as described herein.

The previously discussed modules, devices, systems, or other elements can be implemented in hardware, software, or any combination thereof. Each module can include one or more computer systems. When a module includes more than one computer system, the functions of the module can be distributed across the multiple computer systems in a symmetric manner such that each computer system performs the same type of tasks, or in an asymmetric manner such that two computer systems of the module can perform different tasks.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and can not be drawn to scale. Certain proportions within the illustrations can be exaggerated, while other proportions can be minimized. Accordingly, the disclosure and the FIGS. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features can be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter can be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

1. A method of mitigating an application distributed denial of service (DDoS) attack on a network, the method comprising:
receiving application layer logs at an application DDoS mitigation appliance;
parsing the application layer logs into an application layer forensic file;
comparing a first entry of the application layer forensic file with a first human behavior profile to determine a first malicious qualifier associated with a first application DDoS attack on the network;
parsing the application layer logs into a per-source forensic file;
comparing a first entry of the per-source forensic file with the first malicious qualifier to determine a first malicious Internet protocol (IP) addresses associated with the first application DDoS attack; and
providing the first malicious IP address to a network device, wherein the network device drops network traffic associated with the first application DDoS attack based upon the first malicious IP address.

2. The method of claim 1, further comprising:
comparing a second entry of the per-source forensic file with the first malicious qualifier to determine a second malicious IP addresses associated with the first application DDoS attack; and
providing the second malicious IP address to the network device, wherein the network device further drops network traffic associated with the first application DDoS attack based upon the second malicious IP address.

3. The method of claim 1, further comprising:
comparing a second entry of the application layer forensic file with a second human behavior profile to determine a second malicious qualifier associated with a second application DDoS attack;
comparing a second entry of the per-source forensic file with the second malicious qualifier to determine a second malicious IP addresses associated with the second application DDoS attack; and
providing the second malicious IP address to the network device, wherein the network device drops network traffic associated with the second application DDoS attack based upon the second malicious IP address.

4. The method of claim 1, wherein the application layer logs comprise information related to transactions in a datacenter that are on an Open Systems Interconnection (OSI) model application layer.

5. The method of claim 4, wherein the application layer logs are based upon a field included in an application layer transaction.

6. The method of claim 5, wherein the field comprises one or more of a source field, an authentication field, a Universal Resource Indicator (URI) field, a user agent field, an operating system field, a referrer field, a time stamp field, a search engine field, a search string field, and an error field.

7. The method of claim 1, wherein the application layer logs are received when the application layer logs are generated.

8. The method of claim 1, wherein the application layer logs are received on a periodic basis.

9. The method of claim 1, further comprising:
polling by the application DDoS mitigation appliance to receive the application layer logs;
wherein the application layer logs are received in response to the polling.

10. The method of claim 1, wherein the human behavior profile correlates a sequence of similar transactions with a likelihood of being a malicious sequence of similar transactions.

11. The method of claim 10, wherein the sequence of similar transactions comprises a rapid succession of requests for a same web page.

12. The method of claim 10, wherein the sequence of similar transactions comprises a rapid succession of requests for similar web pages.

13. The method of claim 12, wherein the similar web pages include at least one of successively numbered web pages and successively dated web pages.

14. The method of claim 1, wherein the human behavior profile correlates a particular attribute of a transaction with a likelihood of being a malicious transaction.

15. The method of claim 14, wherein the particular attribute includes a suspicious referrer field.

16. The method of claim 1, wherein the human behavior profile correlates a particular combination of attributes of a transaction with a likelihood of being a malicious transaction.

17. The method of claim 16, wherein the particular combination of attributes includes an operating system field that is consistent with a browser field, and that is also consistent with a requested web page.

18. The method of claim 1, wherein the human behavior profile correlates a particular combination of transactions with a likelihood of being a malicious combination of transactions.

19. The method of claim 18, wherein the particular combination of transactions includes a hypertext transfer protocol (HTTP) GET request that is not followed up with requests for content associated with the HTTP GET request.

20. The method of claim 1, wherein the human behavior profile is provided by a network technician.

21. The method of claim 1, further comprising:
generating the human behavior profile automatically based upon collected data from a datacenter associated with the application DDoS mitigation appliance.

22. The method of claim 21, wherein automatically generating the human behavior profile further comprises:
tracking normal traffic for a website;
creating a profile associated with the normal traffic;
flagging traffic that is dissimilar from the normal traffic as suspicious; and
providing the human behavior profile with a pattern associated with the dissimilar traffic.

23. The method of claim 21, wherein automatically generating the human behavior profile further comprises:
determining that a service of the datacenter is heavily loaded:
tracking traffic that is associated with the service; and
providing the human behavior profile with the traffic.

24. The method of claim 1, wherein comparing the first entry of the application layer forensic file with the first human behavior profile is in response to periodically retrieving a time slice of application layer forensic information form an application layer forensic repository.

25. The method of claim 1, further comprising:
comparing a second entry of the application layer forensic file with a second human behavior profile to determine a first valid qualifier associated with valid traffic on the network;
comparing a second entry of the per-source forensic file with the first valid qualifier to determine a first valid IP addresses associated with the valid traffic; and
providing the first valid IP address to the network device, wherein the network device forwards network traffic associated with the valid traffic based upon the first valid IP address.

26. The method of claim 25, further comprising:
adding the first malicious qualifier to a malicious qualifier list; and
adding the first valid qualifier to a valid qualifier list.

27. The method of claim 26, wherein
comparing the first entry of the per-source forensic file with the first malicious qualifier comprises comparing the first entry of the per-source forensic file with the malicious qualifier list; and
comparing the second entry of the per-source forensic file with the first valid qualifier comprises comparing the second entry of the per-source forensic file with the valid qualifier list.

28. The method of claim 25, further comprising:
adding the first malicious IP address to a malicious IP address list; and
adding the first valid IP address to a valid IP address list.

29. The method of claim 28, wherein
providing the first malicious IP address to the network device comprises providing the malicious IP address list to the network device; and
providing the first valid IP address to the network device comprises providing the valid IP address list to the network device.

30. A distributed denial of service (DDoS) mitigation device comprising:
a processor; and
a memory including code for execution by the processor to:
receive application layer logs;
parse the application layer logs into an application layer forensic file;
compare a first entry of the application layer forensic file with a first human behavior profile to determine a first malicious qualifier associated with a first application DDoS attack on the network;
parse the application layer logs into a per-source forensic file;
compare a first entry of the per-source forensic file with the first malicious qualifier to determine a first malicious Internet protocol (IP) addresses associated with the first application DDoS attack; and
provide the first malicious IP address to a network device, wherein the network device drops network traffic associated with the first application DDoS attack based upon the first malicious IP address.

31. The DDoS mitigation device of claim 30, the memory further including code to:
compare a second entry of the per-source forensic file with the first malicious qualifier to determine a second malicious IP addresses associated with the first application DDoS attack; and
provide the second malicious IP address to the network device, wherein the network device further drops network traffic associated with the first application DDoS attack based upon the second malicious IP address.

32. The DDoS mitigation device of claim 30, the memory further including code to:
compare a second entry of the application layer forensic file with a second human behavior profile to determine a second malicious qualifier associated with a second application DDoS attack;
compare a second entry of the per-source forensic file with the second malicious qualifier to determine a second malicious IP addresses associated with the second application DDoS attack; and
provide the second malicious IP address to the network device, wherein the network device drops network traffic associated with the second application DDoS attack based upon the second malicious IP address.

33. The DDoS mitigation device of claim 30, wherein the application layer logs comprise information related to transactions in a datacenter that are on an Open Systems Interconnection (OSI) model application layer.

34. The DDoS mitigation device of claim 33, wherein the application layer logs are based upon a field included in an application layer transaction.

35. The DDoS mitigation device of claim 34, wherein the field comprises one or more of a source field, an authentication field, a Universal Resource Indicator (URI) field, a user agent field, an operating system field, a referrer field, a time stamp field, a search engine field, a search string field, and an error field.

36. The DDoS mitigation device of claim 30, wherein the application layer logs are received when the application layer logs are generated.

37. The DDoS mitigation device of claim 30, wherein the application layer logs are received on a periodic basis.

38. The DDoS mitigation device of claim 30, the memory further including code to:
poll by the application DDoS mitigation appliance to receive the application layer logs;
wherein the application layer logs are received in response to the polling.

39. The DDoS mitigation device of claim 30, wherein the human behavior profile correlates a sequence of similar transactions with a likelihood of being a malicious sequence of similar transactions.

40. The DDoS mitigation device of claim 39, wherein the sequence of similar transactions comprises a rapid succession of requests for a same web page.

41. The DDoS mitigation device of claim 39, wherein the sequence of similar transactions comprises a rapid succession of requests for similar web pages.

42. The DDoS mitigation device of claim 41, wherein the similar web pages include at least one of successively numbered web pages and successively dated web pages.

43. The DDoS mitigation device of claim 30, wherein the human behavior profile correlates a particular attribute of a transaction with a likelihood of being a malicious transaction.

44. The DDoS mitigation device of claim 43, wherein the particular attribute includes a suspicious referrer field.

45. The DDoS mitigation device of claim 30, wherein the human behavior profile correlates a particular combination of attributes of a transaction with a likelihood of being a malicious transaction.

46. The DDoS mitigation device of claim 45, wherein the particular combination of attributes includes an operating system field that is consistent with a browser field, and that is also consistent with a requested web page.

47. The DDoS mitigation device of claim 30, wherein the human behavior profile correlates a particular combination of transactions with a likelihood of being a malicious combination of transactions.

48. The DDoS mitigation device of claim 47, wherein the particular combination of transactions includes a hypertext transfer protocol (HTTP) GET request that is not followed up with requests for content associated with the HTTP GET request.

49. The DDoS mitigation device of claim 30, wherein the human behavior profile is provided by a network technician.

50. The DDoS mitigation device of claim 30, the memory further including code to:
generate the human behavior profile automatically based upon collected data from a datacenter associated with the application DDoS mitigation appliance.

51. The DDoS mitigation device of claim 50, wherein in automatically generating the human behavior profile, the memory further includes code to:
track normal traffic for a website;
create a profile associated with the normal traffic;
flag traffic that is dissimilar from the normal traffic as suspicious; and
provide the human behavior profile with a pattern associated with the dissimilar traffic.

52. The DDoS mitigation device of claim 50, wherein in automatically generating the human behavior profile, the memory further includes code to:
determine that a service of the datacenter I heavily loaded:
track traffic that is associated with the service; and
provide the human behavior profile with the traffic.

53. The DDoS mitigation device of claim 30, wherein comparing the first entry of the application layer forensic file with the first human behavior profile is in response to periodically retrieving a time slice of application layer forensic information form an application layer forensic repository,

54. The DDoS mitigation device of claim 30, the memory further including code to:
compare a second entry of the application layer forensic file with a second human behavior profile to determine a first valid qualifier associated with valid traffic on the network;
compare a second entry of the per-source forensic file with the first valid qualifier to determine a first valid IP addresses associated with the valid traffic; and
provide the first valid IP address to the network device, wherein the network device forwards network traffic associated with the valid traffic based upon the first valid IP address.

55. The DDoS mitigation device of claim 54, the memory further including code to:
adding the first malicious qualifier to a malicious qualifier list; and
adding the first valid qualifier to a valid qualifier list.

56. The DDoS mitigation device of claim 55, wherein
comparing the first entry of the per-source forensic file with the first malicious qualifier comprises comparing the first entry of the per-source forensic file with the malicious qualifier list; and
comparing the second entry of the per-source forensic file with the first valid qualifier comprises comparing the second entry of the per-source forensic file with the valid qualifier list.

57. The DDoS mitigation device of claim 54, the memory further including code to:
add the first malicious IP address to a malicious IP address list; and
add the first valid IP address to a valid IP address list.

58. The DDoS mitigation device of claim 57, wherein
providing the first malicious IP address to the network device comprises providing the malicious IP address list to the network device; and
providing the first valid IP address to the network device comprises providing the valid IP address list to the network device.

59. A non-transitory computer-readable medium including code for carrying out a method, the method comprising:
receiving at an application DDoS mitigation appliance application layer logs;
parsing the application layer logs into an application layer forensic file;
comparing a first entry of the application layer forensic file with a first human behavior profile to determine a first malicious qualifier associated with a first application DDoS attack on the network;
parsing the application layer logs into a per-source forensic file;
comparing a first entry of the per-source forensic file with the first malicious qualifier to determine a first malicious Internet protocol (IP) addresses associated with the first application DDoS attack; and
providing the first malicious IP address to a network device, wherein the network device drops network traffic associated with the first application DDoS attack based upon the first malicious IP address.

60. The computer-readable medium of claim 59, the method further comprising:
comparing a second entry of the per-source forensic file with the first malicious qualifier to determine a second malicious IP addresses associated with the first application DDoS attack; and
providing the second malicious IP address to the network device, wherein the network device further drops network traffic associated with the first application DDoS attack based upon the second malicious IP address.

61. The computer-readable medium of claim 59, the method further comprising:
comparing a second entry of the application layer forensic file with a second human behavior profile to determine a second malicious qualifier associated with a second application DDoS attack;
comparing a second entry of the per-source forensic file with the second malicious qualifier to determine a second malicious IP addresses associated with the second application DDoS attack; and
providing the second malicious IP address to the network device, wherein the network device drops network traffic associated with the second application DDoS attack based upon the second malicious IP address.

62. The computer-readable medium of claim 59, wherein the application layer logs comprise information related to transactions in a datacenter that are on an Open Systems Interconnection (OSI) model application layer.

63. The computer-readable medium of claim 62, wherein the application layer logs are based upon a field included in an application layer transaction.

64. The computer-readable medium of claim 63, wherein the field comprises one or more of a source field, an authentication field, a Universal Resource Indicator (URI) field, a user agent field, an operating system field, a referrer field, a time stamp field, a search engine field, a search string field, and an error field.

65. The computer-readable medium of claim 59, wherein the application layer logs are received when the application layer logs are generated.

66. The computer-readable medium of claim 59, wherein the application layer logs are received on a periodic basis.

67. The computer-readable medium of claim 59, the method further comprising:
polling by the application DDoS mitigation appliance to receive the application layer logs;
wherein the application layer logs are received in response to the polling.

68. The computer-readable medium of claim 59, wherein the human behavior profile correlates a sequence of similar transactions with a likelihood of being a malicious sequence of similar transactions.

69. The computer-readable medium of claim 68, wherein the sequence of similar transactions comprises a rapid succession of requests for a same web page.

70. The computer-readable medium of claim 68, wherein the sequence of similar transactions comprises a rapid succession of requests for similar web pages.

71. The computer-readable medium of claim 70, wherein the similar web pages include at least one of successively numbered web pages and successively dated web pages.

72. The computer-readable medium of claim 59, wherein the human behavior profile correlates a particular attribute of a transaction with a likelihood of being a malicious transaction.

73. The computer-readable medium of claim 72, wherein the particular attribute includes a suspicious referrer field.

74. The computer-readable medium of claim 59, wherein the human behavior profile correlates a particular combination of attributes of a transaction with a likelihood of being a malicious transaction.

75. The computer-readable medium of claim 74, wherein the particular combination of attributes includes an operating system field that is consistent with a browser field, and that is also consistent with a requested web page.

76. The computer-readable medium of claim 59, wherein the human behavior profile correlates a particular combination of transactions with a likelihood of being a malicious combination of transactions.

77. The computer-readable medium of claim 76, wherein the particular combination of transactions includes a hypertext transfer protocol (HTTP) GET request that is not followed up with requests for content associated with the HTTP GET request.

78. The computer-readable medium of claim 59, wherein the human behavior profile is provided by a network technician.

79. The computer-readable medium of claim 59, the method further comprising:
generating the human behavior profile automatically based upon collected data from a datacenter associated with the application DDoS mitigation appliance.

80. The computer-readable medium of claim 79, wherein in automatically generating the human behavior profile, the method further comprises:
tracking normal traffic for a website;
creating a profile associated with the normal traffic;
flagging traffic that is dissimilar from the normal traffic as suspicious; and
providing the human behavior profile with a pattern associated with the dissimilar traffic.

81. The computer-readable medium of claim 79, wherein in automatically generating the human behavior profile, the method further comprises:
determining that a service of the datacenter I heavily loaded:
tracking traffic that is associated with the service; and
providing the human behavior profile with the traffic.

82. The computer-readable medium of claim 59, wherein comparing the first entry of the application layer forensic file with the first human behavior profile is in response to periodically retrieving a time slice of application layer forensic information form an application layer forensic repository,

83. The computer-readable medium of claim 59, the method further comprising:
comparing a second entry of the application layer forensic file with a second human behavior profile to determine a first valid qualifier associated with valid traffic on the network;
comparing a second entry of the per-source forensic file with the first valid qualifier to determine a first valid IP addresses associated with the valid traffic; and
providing the first valid IP address to the network device, wherein the network device forwards network traffic associated with the valid traffic based upon the first valid IP address.

84. The computer-readable medium of claim 83, the method further comprising:
adding the first malicious qualifier to a malicious qualifier list; and
adding the first valid qualifier to a valid qualifier list.

85. The computer-readable medium of claim 84, wherein
comparing the first entry of the per-source forensic file with the first malicious qualifier comprises comparing the first entry of the per-source forensic file with the malicious qualifier list; and
comparing the second entry of the per-source forensic file with the first valid qualifier comprises comparing the second entry of the per-source forensic file with the valid qualifier list.

86. The computer-readable medium of claim 83, the method further comprising:
adding the first malicious IP address to a malicious IP address list; and
adding the first valid IP address to a valid IP address list.

87. The computer-readable medium of claim 86, wherein
providing the first malicious IP address to the network device comprises providing the malicious IP address list to the network device; and
providing the first valid IP address to the network device comprises providing the valid IP address list to the network device.
